(19) United States
(12) Patent Application Publication
(10) Pub. No.: US 2023/0022984 A1
(43) Pub. Date: Jan. 26, 2023

(54) A MOLD TOOL FOR INJECTION MOLDING

(71) Applicant: LEGO A/S, Billund (DK)

(72) Inventor: Jozsef Gabor KOVACS, Budapest (HU)

(21) Appl. No.: 17/786,594

(22) PCT Filed: Dec. 18, 2020
(86) PCT No.: PCT/EP2020/086924

§ 371 Date: Jun. 17, 2022

(30) Foreign Application Priority Data
Dec. 20, 2019 (DK) PA 2019 70805

(51) Int. Cl. B29C 45/27; B29C 45/32

(52) U.S. Cl. CPC B29C 45/2704; B29C 45/32; B29C 2045/2717

(57) ABSTRACT

An injection-molding tool has at least two separate mold parts forming a set of mold cavities, and a set of runner channels extending between the mold inlet and leading melt flow to the mold cavities. The set of runner channels comprises a number of junctions, each junction dividing a downstream end of a primary runner channel extending upstream from the junction into two or more separate secondary runner channels extending downstream from the junction. A stretch of the downstream end of the primary runner has a cross section area being smaller than the cross section area of the primary runner further upstream from the junction.

### CROSS-REFERENCE

The present application claims priority to Danish Patent Application No. PA 201970805 dated Dec. 20, 2019, and is a U.S. national stage application under 35 U.S.C. 371 of co-pending International Application No. PCT/EP2020/086924 filed on Dec. 18, 2020, the content of each are incorporated by reference herein in their entirety for all purposes.

### FIELD OF THE DISCLOSURE

The subject disclosure relates to an injection-molding tool, and more particularly to an injection-molding tool for being mounted in an injection-molding apparatus for automated molding of work pieces in plastics.

### BACKGROUND

When designing injection-molding tools of the above mentioned kind it is a recurring challenge to ensure even supply of molten material to an increasing number of separate mold cavities. This is primarily due to the problem that even though the all the melt supplied to the injection-molding tool has the same temperature, then some of the material in the flowing through the runner system is exposed to a higher shear and thereby having a higher temperature and a lower viscosity than other parts of the material, and that the geometry of the runner systems, especially at runner junctions where a single primary runner is divided into two or more secondary runners or branches, may lead more of the melt having a higher temperature and lower viscosity to one mold cavity than to another mold cavity.

Therefore several different constructions of runner channels such as especially cold runner channels are suggested in order to ensure even distribution of the molten material often referred to as balancing the runner. In the prior art a lot of different examples of such runner systems are suggested comprising different embodiments of melt flippers and melt mixers.

### SUMMARY

Based on this, it is the object of the subject disclosure to provide an injection-molding tool with runners, such as cold runners, being well balanced, and allowing on the one hand that the cold runners or injection runners convey molten material to all mold cavities, but without using complex runner geometry.

In one embodiment of the subject disclosure, the downstream end of the primary runner has a cross section area being smaller than the cross section area of the primary runner further upstream from the junction, and smaller than the largest cross section of the secondary runners.

The baling effect is obtained due to the fact that the reduced area of the runner at the junction thereby locally creates a high shear of more of the melt flowing through the junction and at the same time it provides a mixing effect so that the high shear material and the low shear material is more mixed after the junction than it was before the junction.

According to a preferred embodiment of the molding tool, the cross section area of the downstream end of the primary runner gradually decreases in the flow direction.

Furthermore the cross section area of the upstream end of each of the secondary runners may advantageously be smaller than the cross section area of the secondary runner further downstream from the junction.

In this relation, the cross section area of the upstream end of the secondary runner may furthermore gradually increase in the flow direction.

Preferably the smallest cross section area of at least one primary or secondary runner connected via a junction is less than 75% and preferably less than 50% of the cross section area of the same runner at a distance from the junction. The selected optimal reduction depends on e.g. the characteristics of the plastic material supplied though the runners, and the aim is to increase the shear rate in the supplied plastic material significantly at least before the junction.

In an especially simple embodiment of the subject disclosure, one of or both the primary and the secondary runners are formed by groves arranged in the abutting side face of either the inlet mold part or the secondary mold part, or each of the primary and the secondary runners at least at a distance downstream and upstream from the junction are formed by groves arranged in only one of the abutting side faces of either the inlet mold part or the secondary mold part.

### BRIEF DESCIPTION OF THE DRAWINGS

FIG. 1 is an overhead perspective view of an injection molding tool.

FIG. 2 is an enlarged overhead perspective view, showing a section of the injection molding tool in FIG. 1 including runner channels.

FIG. 3 is an overhead perspective view of a junction insert forming one junction part of the runner channels shown in FIG. 2.

FIG. 4 is an overhead perspective view of a junction insert forming another junction part of the runner channels shown in FIG. 2.

### DETAILED DESCRIPTION

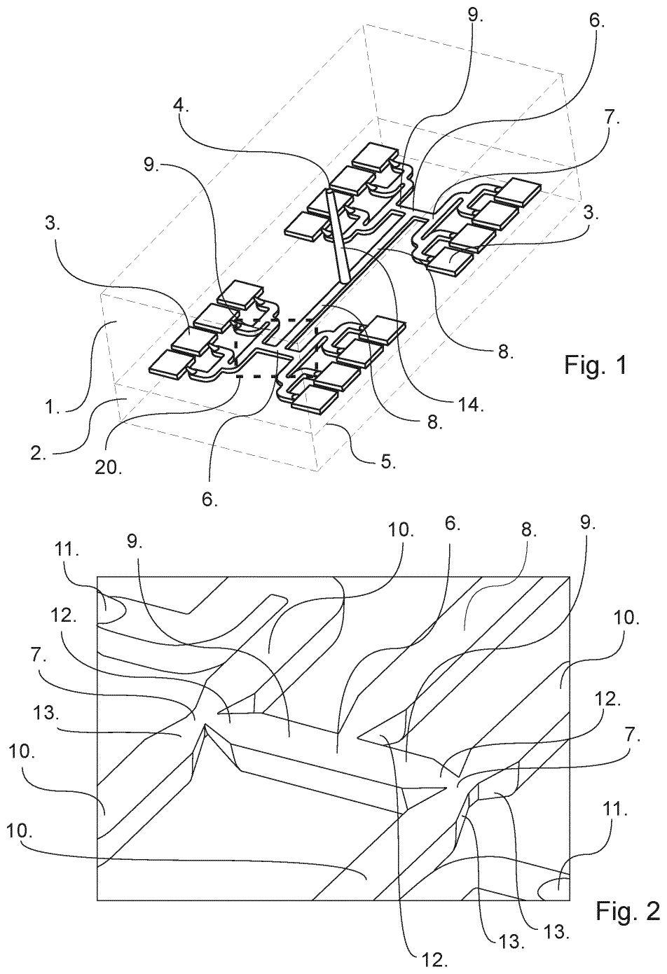

FIG. 1 illustrates a conventional injection molding tool with an inlet mold part 1 and a second mold part shown with dotted lines. The inlet mold part 1 and the second mold part 2 have abutting surfaces forming a separation plane 5 also shown in dotted lines. The inlet mold part has an inlet 4 connected to multiple mold cavities 3 via a sprue 14 and a set of runner channels 8, 9 and a set of runner junctions 6, 7. In FIG. 1 the design of the mold cavities 3, the sprue 14, the runner channels 8, 9 and the runner junctions 6, 7 are illustrated as the shape of the molded component, including the sprue, the runners and the molded products/work pieces, that are produced in such an injection molding tool.

An embodiment of the subject disclosure will, in the following, be explained in principle with reference to the embodiment of an injection molding tool as shown in FIG. 1, but it will be evident to one having ordinary skill in the art that the subject disclosure may also be implemented in various different types of injection molding tools, such as molding tools having an intermediate mold part between the inlet mold part 1 and the second mold part 2.

In this relation, FIG. 2 shows an enlarged section 20 of the set of runners as shown in FIG. 1, where runner junctions 6, 7 divides primary runner channels 8, 9 into secondary runner channels 9, 10 respectively, so that the primary runners 8 extending from the sprue 14 are divided into secondary runners 9 by the runner junction 6, and the secondary runners 9, when looked at from the runner junctions 7 are now primary runners 9, being divided into secondary runner 10 via the runner junctions 7. In this way the set of runners may be further subdivided several times into further secondary runners that the most downstream end of the runners is connected to the mold cavities 3 via runner gates 11.

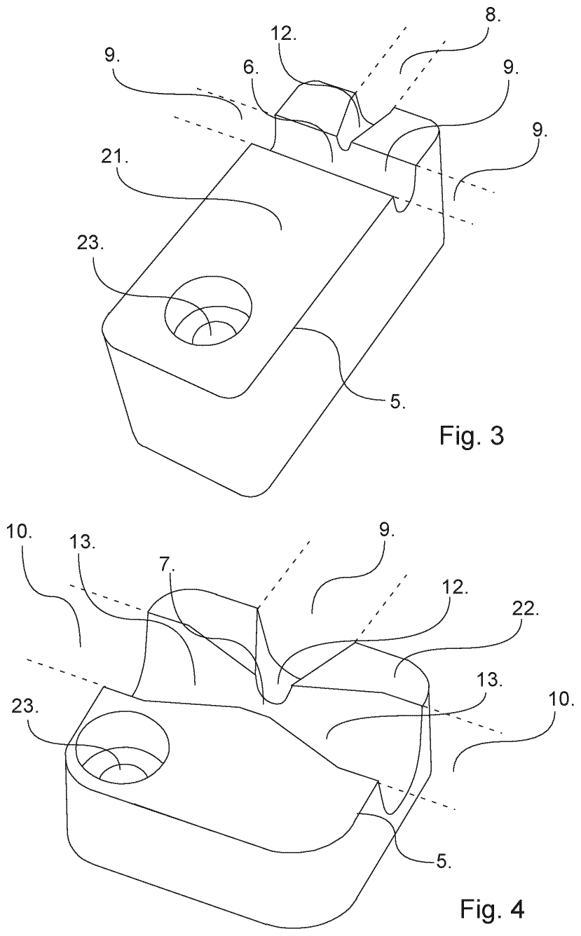

FIGS. 3 and 4 disclose two junction inserts 21, 22 each forming a runner junction 6, 7 as shown in FIG. 2 for dividing the most downstream end of a primary runner channel 8, 9 (partly shown in dotted lines), into the most upstream end of the secondary runner channels 9, 10 respectively (partly shown with dotted lines). The junction inserts are made as blocks being adapted for insertion into a correspondingly shaped socket in the second mold part 2, and a screw hole 23 is arranged for the purpose of securing the junction inserts in the mold part 2. In this way it is possible to change the junction inserts with other junction inserts having different geometries, e.g. when the injection molding tool is to be used with other plastic materials, or to work under different conditions.

With the purpose of ensuring more even filling of the mold cavities 3, the downstream end of the primary runner 8 as shown in FIG. 3 has a cross section area being significantly reduced with respect to the cross section of the same runner 8 at a position upstream. In the embodiment shown in FIG. 3, a stretch 12 of the downstream end of the primary runner 8 is gradually decreasing in the flow direction in the runner 8, and it has its smallest cross section just before the junction 6 where the primary runner channel is divided into the two secondary runner channels 9.

In the same way the secondary runners 9 in FIG. 3 becomes the primary runner 9 in the embodiment shown in FIG. 4 where the primary runner 9 in the same way has a significantly reduced cross section at its most downstream position just before the junction 7, where the primary runner 9 is divided into two secondary runners 10. In this embodiment, however, each of the secondary runner channels 10 at their most upstream end has the smallest cross section area and the cross section at a stretch 13 of the upstream end of each of the secondary runner channels 10 are gradually increasing in the flow direction.

From the description above it will be apparent to one having ordinary skill in the art that the subject disclosure may be implemented in many different embodiments apart from the embodiment shown in the figures. As mentioned above, the subject disclosure may also be used e.g. with molding tools having an intermediate mold part between the inlet mold part 1 and the second mold part 2, or molding tools equipped with a hot runner system, or even a combination of hot and cold runners. Furthermore, it will also be apparent to one having ordinary skill in the art that the runner system may comprise more or less mold cavities requiring more or fewer runner channels and junctions for distribution of the plastic material to the mold cavities.

1. An injection-molding tool configured for being mounted in an injection-molding apparatus for automated molding of work pieces in plastics, the injection-moulding tool, in its closed position, comprising:
at least two separate mold parts forming a set of mold cavities, the separate mold parts having:
an inlet mold part having a mold inlet for injection of liquid plastics from the injection-moulding apparatus; and
a second mold part, the inlet and second mold parts having abutting side faces facing a common mold separation plane, wherein:
the abutting side faces form a set of runner channels extending between the mold inlet and leading melt flow to the mold cavities,
the set of runner channels have a plurality of junctions, each junction dividing a downstream end of a primary runner channel extending upstream from the junction into two or more separate secondary runner channels extending downstream from the junction, and
a stretch of the downstream end of the primary runner has a cross section area being smaller than the cross section area of the primary runner further upstream from the junction, and smaller than the largest cross section of the secondary runners.

2. An injection-molding tool according to claim 1, wherein the cross section area of a most upstream end of the stretch of the downstream end of the primary runner gradually decreases in a flow direction.

3. An injection-molding tool according to claim 2, wherein a most downstream end of the stretch of the downstream end of the primary runner has a uniform cross section area being smaller than the cross section area of the primary runner further upstream from the junction.

4. An injection-molding tool according to claim 1, wherein the cross section area of a stretch of the upstream end of each of the secondary runners is smaller than the cross section area of the secondary runner further downstream from the junction.

5. An injection-molding tool according to claim 2, wherein a most upstream end of a stretch of an upstream end of the primary runner has a uniform cross section.

6. An injection-molding tool according to claim 5, wherein the cross section area of a stretch of an upstream end of the secondary runner gradually increases in a flow direction.

7. (canceled)

8. An injection-molding tool according to claim 1, wherein both the primary and the secondary runners are formed by groves arranged in only one of the abutting side faces of either the inlet mold part or the secondary mold part.

9. An injection-molding tool according to claim 1, wherein each of the primary and the secondary runners, at least at a distance downstream and upstream from the junction, are formed by groves arranged in only one of the abutting side faces of either the inlet mold part or the secondary mold part.

10. An injection-molding tool according to claim 1, wherein the downstream end of the primary runner and an upstream end of the secondary runners are arranged in an insert that can be releasably attached to the inlet mold part or the secondary mold part forming the remaining parts of the primary and secondary runners.

11. An injection-molding cast comprising:
a primary runner channel having:
an upstream portion in communication with an inlet of the injection-molding cast; and
a downstream portion having a cross-section that tapers to a narrow end;
a first runner junction channel intersecting the downstream portion of the primary runner channel and receiving flow therefrom, the first runner junction channel having a cross-section that tapers to a narrow end toward a downstream portion;
a second runner junction channel connected to the downstream portion of the first runner junction channel and receiving flow therefrom, the second runner junction channel having a cross-section that gradually increases toward a downstream portion;
a secondary runner channel connected to the downstream portion of the second runner junction and receiving flow therefrom; and
a molding cavity receiving flow from the secondary runner channel.

12. The mold of claim 11, further comprising a secondary mold opposite the injection-molding cast to close the injection-molding cast.

13. The mold of claim 11, wherein the first and second runner junction channel arc arranged in one or more inserts that can be releasably connected to the injection-molding cast.

14. The mold of claim 11, further comprising a plurality of molding cavities receiving flow from the secondary runner channel.

15. A mold for delivering molten material to mold cavities, the mold comprising:
a sprue configured for receiving molten material at an inlet of the mold;
a primary runner channel in fluid communication with the sprue, the primary runner channel for receiving the molten material;
a secondary runner channel in fluid communication with and downstream of the primary runner channel;
a tertiary runner channel in fluid communication with and downstream of the secondary runner channel; and
a molding cavity receiving flow from the tertiary runner channel.

16. The mold of claim 15, wherein the primary runner channel has a cross-sectional area that tapers downstream to facilitate the flow of the molten material.

17. The mold of claim 15, wherein the secondary runner channel has a cross-sectional area that tapers downstream to facilitate the flow of the molten material, and the tertiary runner channel has a cross-sectional area that increases downstream to facilitate the flow of the molten material.

18. The mold of claim 15, further comprising a quaternary runner channel opposite the tertiary runner channel, also in fluid communication with and downstream of the secondary runner channel.

19. The mold of claim 18, further comprising:
a quinary runner channel in fluid communication with and downstream of the primary runner channel, the quinary runner channel opposite the secondary runner channel such that the sprue is disposed between the quinary and secondary runner channel;
a senary runner channel in fluid communication with and downstream of the quinary runner channel; and
a septenary runner channel opposite the senary runner channel, also in fluid communication with and downstream of the quinary runner channel, the septenary runner channel.

20. The mold of claim 19, further comprising a plurality of molding cavities receiving flow from the tertiary, quaternary, senary, and septenary runner channels.
